(19) United States
(12) Patent Application Publication
(10) Pub. No.: US 2019/0141263 A1
(43) Pub. Date: May 9, 2019

(54) CONTROL DEVICE AND CONTROL METHOD

(71) Applicant: SONY CORPORATION, Tokyo (JP)

(72) Inventors: Masaru Takamoto, Kanagawa (JP); Shigetaka Kudo, Kanagawa (JP)

(73) Assignee: SONY CORPORATION, Tokyo (JP)

(21) Appl. No.: 16/306,271

(22) PCT Filed: Mar. 8, 2017
(86) PCT No.: PCT/JP2017/009256

§ 371 Date: Nov. 30, 2018

(30) Foreign Application Priority Data
Jun. 9, 2016 (JP) 2016-115206

(51) Int. Cl. H04N 5/345; H04N 5/378; H04N 5/355

(52) U.S. Cl. CPC H04N 5/345; H04N 5/3559; H04N 5/378

(57) ABSTRACT

[Object] To realize a dynamic imaging control for each of imaging regions.

[Solution] Provided is a control device including an imaging control section that controls imaging for a plurality of imaging regions to be set in an imaging device on a basis of a plurality of trigger signals. The trigger signals may correspond to the imaging regions. In addition, provided is a control method executed by a control device, the control method including controlling imaging for a plurality of imaging regions to be set in an imaging device on a basis of a plurality of trigger signals.

### TECHNICAL FIELD

The present disclosure relates to a control device and a control method.

### BACKGROUND ART

Various imaging devices corresponding to imaging targets or intended uses have been proposed. Moreover, in a single imaging device, techniques have been developed for acquiring images in a plurality of imaging regions on a basis of different imaging conditions. For example, in Patent Literature 1, a technique has been disclosed that controls a high resolution region in which reading-out is performed for all pixels and a low resolution region in which reading out is performed for pixels reduced by thinning out, individually in a CMOS (Complementary Metal Oxide Semiconductor) sensor.

### CITATION LIST

### Patent Literature

Patent Literature 1: JP 2007-235387A

### DISCLOSURE OF INVENTION

### Technical Problem

For example, in the technique described in Patent Literature 1, exposure for a high resolution region is started at a predetermined timing such that the exposure is ended before or after a timing at which the reading-out by the thinning-out in the ow resolution region is ended. Therefore, for example, in the case where the technique described in Patent Literature 1 is used, it may be possible to acquire an image in which exposure is different between the low resolution region and the high resolution region.

However, for example, as in the technique described in Patent Literature 1, in the case of controlling exposure time in the low resolution region and the high resolution region, the imaging by each of the above-described regions is controlled on the basis of setting set in advance. For this reason, in the technique described in Patent Literature 1, it may be difficult to change an imaging condition flexibly in accordance with a condition.

Then, in the present disclosure, proposed are a novel and improved control device and control method that can realize a dynamic imaging control for each of imaging regions.

### Solution to Problem

According to the present disclosure, there is provided a control device including an imaging control section that controls imaging for a plurality of imaging regions to be set in an imaging device on a basis of a plurality of trigger signals.

In addition, according to the present disclosure, there is provided a control method executed by a control device, the control method including controlling imaging for a plurality of imaging regions to be set in an imaging device on a basis of a plurality of trigger signals.

### Advantageous Effects of Invention

As having described in the above, according to the present disclosure, it becomes possible to realize a dynamic imaging control for each of the imaging regions. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a constitution diagram of a control device according to an embodiment of the present disclosure.

FIG. 2 is an explanatory diagram for describing a first control example according to the same embodiment.

FIG. 3 is an explanatory diagram for describing a second control example according to the same embodiment.

FIG. 4 is an explanatory diagram for describing a third control example according to the same embodiment.

FIG. 5 is an explanatory diagram for describing a fourth control example according to the same embodiment.

FIG. 6 is an explanatory diagram for describing a converting circuit capable of adjusting a gain according to the same embodiment.

FIG. 7 is an explanatory diagram for describing a converting circuit capable of adjusting a gain according to the same embodiment.

FIG. 8 is an explanatory diagram for describing a converting circuit capable of adjusting a gain according to the same embodiment.

FIG. 9 is a block diagram depicting an example of schematic configuration of a vehicle control system.

FIG. 10 is a diagram of assistance in explaining an example of installation positions of an outside-vehicle information detecting section and an imaging section.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

In this connection, description shall be given in following order.

1. Embodiment

1.1. Functional constitution example of control device

1.2. Hardware constitution example of control device

1.3. One example of imaging control by imaging control section

1.4. Application example of control device according to present embodiment

### 1. Embodiment

[1.1. Functional Constitution of Control Device]

In recent years, there exists widely a system that uses an imaging device installed at a fixed point, such as an industrial camera used in a factory, a physical distribution system, etc., a camera used in an ITS (Intelligent Transport Systems), and a security camera. For example, in the case of a system using the above-described industrial camera, by imaging products etc. flowing on a line with an imaging device, it is possible to use an acquired captured image (moving image or still image) for various uses, such as the inspection of the products.

On the other hand, in the above-described industrial system, in the case where there exist portions different greatly in difference between light and darkness on the surface of one imaging target, it may be difficult to image all the portions clearly with a single imaging device.

For this reason, in systems in industrial fields etc., an imaging device capable of imaging clearly an imaging target that includes portions different greatly in difference between light and darkness, is required.

The control device according to an embodiment of the present disclosure has been conceived by paying attention to the above-described points. For this reason, the control device according to the present embodiment may have a function that controls imaging for each of a plurality of imaging regions to be set for an imaging device. At this time, it is possible for the control device according to the present embodiment to control imaging for each of the plurality of above-described imaging regions on the basis of a plurality of trigger signals to be input.

Here, the imaging regions according to the present embodiment may be, for example, regions to be set for a pixel circuit included in an imaging device. Moreover, a plurality of imaging regions according to the present embodiment may be regions that do not overlap with each other.

As the imaging device according to the present embodiment, for example, an imaging device including a CMOS as an image sensor is cited. The image sensor included in the imaging device according to the present embodiment may include only the CMOS, or may be a stacked type image sensor in which other components, such as a CCD (Charge Coupled Device), are stacked on the CMOS.

In this connection, the imaging device according to the present embodiment is not limited to the example shown in the above. For example, as the imaging device according to the present embodiment, an imaging device including an arbitrary image sensor to which a global shutter can be applied, is cited.

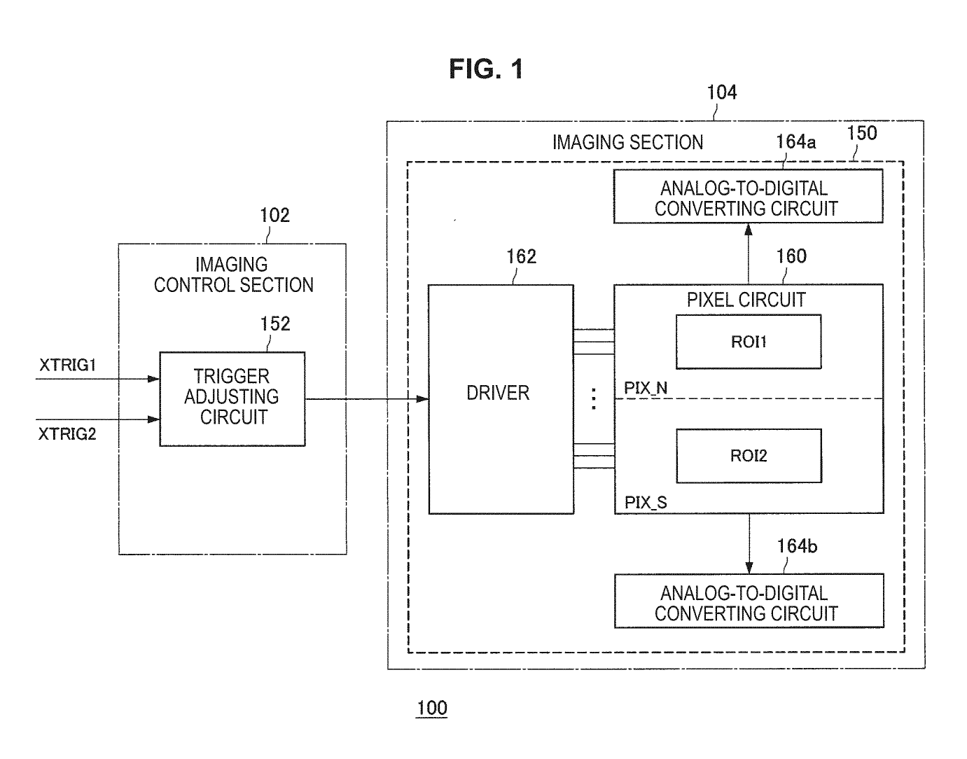

Hereinafter, with reference to FIG. 1, a functional constitution example of a control device 100 according to the present embodiment is described. FIG. 1 is a constitution diagram showing one example of a logical constitution and physical constitution of the control device 100 according to the present embodiment. Referring to FIG. 1, the control device 100 according to the present embodiment includes an imaging control section 102 and an imaging section 104.

(Imaging Control Section 102)

The imaging control section 102 has a function that controls imaging for each of a plurality of imaging regions to be set in an imaging device on the basis of a plurality of trigger signals. In one example shown in FIG. 1, the imaging control section 102 can control imaging for each of a plurality of imaging regions to be set in a later-mentioned imaging section 104 on the basis of a plurality of trigger signals XTRIG1 and XTRIG2 to be input.

Here, the trigger signal according to the present embodiment may be a signal to be generated on the basis of various conditions. The trigger signal according to the present embodiment may be, for example, a signal to be generated on the basis of a fact that a separate detection means has detected an imaging target, or may be a signal to be generated on the basis of an instruction operation (for example, depression of a shutter button etc.) related to imaging. As the above-described separate detection means, for example, a detecting device using infrared light, a detecting device using another imaging device, or the like is cited. Moreover, the trigger signal according to the present embodiment may be a signal to be generated on the basis of conditions, such as the time having been set beforehand.

The imaging control section 102 according to the present embodiment receives a plurality of trigger signals generated as described in the above via a later-mentioned communication section (or directly), and can control imaging for each of the imaging regions on the basis of the plurality of trigger signals. That is, the imaging control section 102 according to the present embodiment can realize dynamic imaging control on the basis of the plurality of trigger signals to be input.

Moreover, each of the trigger signals according to the present embodiment may be a signal corresponding to an imaging region. At this time, a single trigger signal may be a signal corresponding to a plurality of imaging regions. For example, in the case where four imaging regions are disposed in the imaging section 104, on the basis of the trigger signal XTRIG1, the imaging control section 102 may control the imaging of two imaging regions corresponding to the trigger signal XTRIG1. Moreover, on the basis of the trigger signal XTRIG2, the imaging control section 102 can control the imaging of two imaging regions corresponding to the trigger signal XTRIG2.

Moreover, a single trigger signal may be a signal corresponding to a single imaging region. For example, in the case where two imaging regions are disposed in the imaging section 104, on the basis of the trigger signal XTRIG1, the imaging control section 102 may control the imaging of a single imaging region corresponding to the trigger signal XTRIG1. Moreover, on the basis of a trigger signal XTRIG2, the imaging control section 102 can control the imaging of two imaging regions corresponding to the trigger signal XTRIG2.

That is, the imaging control section 102 according to the present embodiment can also perform the imaging control for an imaging region on the basis of a trigger signal corresponding to the imaging region.

In more concrete terms, the imaging control section 102 according to the present embodiment may control exposure for each of the imaging regions. Here, “exposure” refers to an operation in an image sensor that converts incident light into electric charges and accumulates the converted electric charges. That is, the imaging control section 102 according to the present embodiment can control an accumulation period of electric charges in an imaging region on the basis of a plurality of trigger signals.

In this connection, accumulation periods of electric charges controlled by the imaging control section 102 for respective imaging regions may include a different period. That is, it is possible for the imaging control section 102 according to the present embodiment to control such that an accumulation period of electric charges differs between imaging regions. According to the above-described function which the imaging control section 102 has, even if an imaging target includes portions different greatly in difference between light and darkness, each of the portions can be made to be imaged with different exposure, and it becomes possible to acquire a clearer captured image.

In order to realize the above-described effects, on the basis of a change of a trigger signal corresponding to an imaging region, the imaging control section 102 according to the present embodiment may cause accumulation of electric charges in the imaging region to be started. That is, on the basis of a change of a trigger signal related to starting of accumulation, the imaging control section 102 according to the present embodiment causes accumulation of electric charges in the imaging region corresponding to the trigger signal to be started, whereby it is possible to control timing related to starting of accumulation for each of the imaging regions.

Moreover, on the basis of a trigger signal having changed firstly among trigger signals corresponding to imaging regions in which accumulation of electric charges has been started, the imaging control section 102 according to the present embodiment may cause the accumulation of electric charges in the imaging regions in which accumulation of electric charges has been started, to be ended. That is, on the basis of a change of a trigger signal having indicated the ending of accumulation firstly among a plurality of trigger signals, the imaging control section 102 according to the present embodiment can cause the accumulation of electric charges to be ended in all the imaging regions that are performing the accumulation of electric charges.

As having described in the above, the imaging control section 102 according to the present embodiment can control an accumulation period of electric charges for each of the imaging regions on the basis of a plurality of trigger signals. In this connection, the control of an accumulation period of electric charges according to the present embodiment will be described later in detail.

Moreover, the imaging control section 102 according to the present embodiment may control a gain at the time of reading out electric charges for each of the imaging regions on the basis of a plurality of trigger signals. That is, the imaging control section 102 according to the present embodiment can control the lightness of a captured image acquired for each of the imaging regions on the basis of a plurality of trigger signals.

At this time, the above-described gains controlled by the imaging control section 102 for the respective imaging regions may include a gain different in size. That is, it is possible for the imaging control section 102 according to the present embodiment to control such that a gain at the time of reading out electric charges becomes different between imaging regions. According to the above-described function which the imaging control section 102 has, even if an imaging target includes portions different greatly in difference between light and darkness, each of the portions can be made to be imaged with a different gain, and it becomes possible to acquire a clearer captured image.

In order to realize the above-described effects, the imaging control section 102 according to the present embodiment may cause reading out of electric charges in each of the imaging regions to be started on the basis of a fact that the transferring of the accumulated electric charges in all the imaging regions has been completed.

Moreover, in the case where the reading-out of the transferred electric charges has been completed in an imaging region, the imaging control section 102 according to the present embodiment may change the above-described gain in an imaging region for which reading-out is to be performed at the next. That is, after the transferring of electric charges has been completed in all the imaging regions, the imaging control section 102 according to the present embodiment reads out electric charges with a different gain for each of the imaging regions, whereby it is possible to control the lightness of an image to be imaged for each of the imaging regions.

As having described in the above, the imaging control section 102 according to the present embodiment can control a gain related to the reading-out of electric charges for each of the imaging regions on the basis of plurality of trigger signals. In this connection, the control of a gain according to the present embodiment will be described later in detail.

Moreover, in the above, the description has been given for the case where the imaging control section 102 controls imaging for each of the imaging regions on the basis of a plurality of trigger signals. On the other hand, the imaging control section 102 according to the present embodiment may control the imaging of all the imaging regions on the basis of a single trigger signal. For example, the imaging control section 102 can control the imaging of all the imaging regions to be set in the imaging section 104 on the basis of the trigger signal, XTRIG1, shown in the above.

In this case, for example, the imaging control section 102 may determine whether to perform a different control for each of the imaging regions, or whether to perform the same control for all the imaging regions, depending on a mode to be set. That is, the imaging control section 102 according to the present embodiment can control the imaging of the imaging region on the basis of a mode to be set. At this time, the above-described mode may include, for example, a first mode that controls imaging for each of the imaging regions on the basis of a plurality of trigger signals and a second mode that controls the imaging of all the imaging regions on the basis of a single trigger signal. The imaging control section 102 can control the imaging of the imaging section 104 on the basis of either the first mode or the second mode to be set.

In this connection, the above-described mode may be set, for example, on the basis of an operation of a user. The user can set an arbitrary mode corresponding to an imaging target etc. through a later-mentioned operation input section. Moreover, the above-described mode can also be set, for example, to be switched according to a time condition etc. having been set beforehand. In a factory etc., in the case where products etc. flowing on the same line change depending on time, by setting so as to change the mode on the basis of a time condition, it is possible to realize imaging control corresponding to an imaging target.

(Imaging Section 104)

The imaging section 104 includes an imaging device and generates a captured image by imaging. The imaging section 104 according to the present embodiment may have a function that performs imaging for each of the imaging regions on the basis of the control of the imaging control section 102.

(Other Constitution)

Moreover, the control device 100, for example, includes a control section (not shown), a ROM (Read Only Memory, not shown), a RAM (Random Access Memory, not shown), a memory section (not shown), a communication section (not shown), an operating section (not shown) that allows a user to operate, a display section (not shown) that displays various screens on a display screen, and so on. The control device 100 connects between the above-described constitution components via, for example, buses as data transmission paths.

The control section (not shown) includes one or two or more processors including an arithmetic circuit such as an MPU (Micro Processing Unit), various processing circuits, and so on, and controls the whole control device 100. Moreover, a control section (not shown) may achieve, in the control device 100, for example, a role of the imaging control section 102.

In this connection, the imaging control section 102 may be constituted by a dedicated (or, general-purpose) circuit (for example, a processor etc. separated from the control section (not shown)) capable of executing the process of the imaging control section 102.

The ROM (not shown) memorizes programs used by the control section (not shown) and data for control, such as arithmetic parameters. The RAM (not shown) memorizes temporarily programs etc. executed by the control section (not shown).

The memory section (not shown) is a memory means equipped in the control device 100, and memorizes, for example, various data such as data related to the control method according to the present embodiments and various applications.

Here, as the memory section (not shown), for example, magnetic recording media, such as a hard disk (Hard Disk), nonvolatile memories (nonvolatile memory), such as a flash memory (flash memory), and so on, are cited. Moreover, the memory section (not shown) may be detachable from the control device 100.

The communication section is a communicating means equipped in the control device 100, and performs communication wirelessly or by wire with an external device, such as an external imaging device and an external recording medium and an external apparatus, such as a server, via a network (or directly). As the communication section (not shown), for example, a communications antenna and an RF (Radio Frequency) circuit (wireless communication), an IEEE802.15.1 port and a transceiver circuit (wireless communication), an IEEE802.11 port and a transceiver circuit (wireless communication), a LAN (Local Area Network) terminal and a transceiver circuit (cable communication), and the like are cited.

The operation input section (not shown) is an operation input means equipped in the control device 100, and receives an operation input by a user. As the operation input section (not shown), for example, a button, a rotary type selector, such as a direction key and a jog dial, or a combination of these, is cited.

A display section (not shown) is a display means equipped in the control device 100, and outputs various kinds of visual information. As the display section (not shown), for example, a liquid crystal display (Liquid Crystal Display) or an organic EL display (Organic Electro-Luminescence Display, or an OLED display (called also Organic Light Emitting Diode Display), is cited.

In the above, the functional constitution of the control device 100 according to the present embodiment has been described. In this connection, the functional constitution of the control device 100 according to the present embodiment is not limited to the constitution example shown in FIG. 1.

For example, in the case where the control device 100 according to the present embodiment controls imaging in an external imaging device on the basis of a trigger signal, the control device 100 may not include the imaging section 104 shown in FIG. 1.

[1.2. Hardware Constitution—Example of Control Device 100]

Successively, with reference to FIG. 1, a hardware constitution example of the control device 100 according to the present embodiment is described.

Referring to FIG. 1, the control device 100 according to the present embodiment includes, for example, an imaging device 150 and a trigger adjusting circuit 152. Moreover, the control device 100 is driven, for example, by electric power supplied from an internal electrical power source such as a battery equipped in the control device 100, or electric power supplied from an external electrical power source being connected.

### (Imaging Device 150)

The imaging device 150 functions as the imaging section 104. The imaging device 150 includes, for example, a lens (not shown) of an optical system, an image sensor (not shown), such as a CMOS, a pixel circuit 160 corresponding to an image sensor (not shown), a driver 162, and analog-to-digital converting circuits 164a and 164b.

### (Pixel Circuit 160)

The pixel circuit 160 includes, for example, a transistor, a capacitive element, and so on, in which accumulation of charges according to photoelectric conversion in each pixel, initialization of each pixel, etc. are performed in accordance with signals transmitted from the driver 162. As the above-described transistor, for example, a bipolar transistor, a FET (Field-Effect Transistor), such as a TFT (Thin Film Transistor) and a MOSFET (Metal-Oxide-Semiconductor Field Effect Transistor), and so on, are cited. Moreover, as the capacitive element, a capacitor etc. are cited.

Moreover, the plurality of above-mentioned imaging regions may be set in the pixel circuit 160 according to the present embodiment. In one example shown in FIG. 1, two imaging regions PIX_N and PIX_S are set in the pixel circuit 160. In the case of one example shown in FIG. 1, for example, the imaging region PIX_N may be an imaging region corresponding to the trigger signal XTRIG1. Moreover, the imaging region PIX_S may be an imaging region corresponding to the trigger signal XTRIG2. In this way, the imaging region according to the present embodiment is a region of the pixel circuit 160 corresponding to each of the trigger signals.

Moreover, in the pixel circuit 160 according to the present embodiment, an arbitrary ROI (Region Of Interest) may be set. In one example shown in FIG. 1, a ROI1 and a ROI2 are set in the imaging regions PIX_N and PIX_S respectively in the pixel circuit 160. In this way, in the case where the ROI is set in the pixel circuit 160, the imaging region according to the present embodiment may be one showing the ROI. The imaging region according to the present embodiment can be defined as a predetermined region on the pixel circuit 160 controlled on the basis of a trigger signal.

In this connection, although FIG. 1 exemplifies a case where the pixel circuit 160 includes two imaging regions PIX_N and PIX_S, the pixel circuit 160 according to the present embodiment may include three or more imaging regions. In this case, for example, the third imaging region may be set, for example, as an imaging region corresponding to a trigger signal XTRIG3 (not shown). Moreover, for example, the above-described third imaging region may be set as an imaging region corresponding to the trigger signal XTRIG1 or XTRIG2. The trigger signal according to the present embodiment may correspond to a plurality of imaging regions.

Moreover, although FIG. 1 exemplifies a case where two imaging regions PIX_N and PIX_S have the same size, the plurality of imaging regions according to the present embodiment may be set to have respective different sizes. Moreover, for example, in the case where the imaging device 150 has a constitution including a stacked type region ADC (Analog-to-Digital Converter), it is possible to set a region of an arbitrary shape capable of being set in the pixel circuit 160, as an imaging region.

(Driver 162)

The driver 162 drives the pixel circuit 160 by generally transmitting signals to the pixel circuit 160. In particular, the driver 162 according to the present embodiment can perform the above-described driving for each of the imaging regions set in the pixel circuit 160 on the basis of the control of the later-mentioned trigger adjusting circuit 152. On the basis of a control signal from the later-mentioned trigger adjusting circuit 152, the driver 162 according to the present embodiment may drive an imaging region corresponding to the control signal. Moreover, although not shown, a plurality of drivers 162 may be disposed correspondingly to the number of imaging regions. In this case, each of the plurality of drivers 162 may drive a corresponding one of the imaging regions.

(Analog-to-Digital Converting Circuit 164)

Each of the analog-to-digital converting circuits 164a and 164b converts an analog signal corresponding to photoelectric conversion from each pixel into a digital signal (image data). The analog-to-digital converting circuits 164a and 164b according to the present embodiment may operate without depending on the imaging region. For example, the imaging control section 102 according to the present embodiment makes both of the analog-to-digital converting circuits 164a and 164b read out the imaging region PIX_N, and thereafter, switches a gain and makes them read out the imaging region PIX_S.

On the other hand, as mentioned later, the analog-to-digital converting circuits 164a and 164b according to the present embodiment may be a converting circuit (converting circuit capable of switching a gain of an analog signal) capable of adjusting a gain of an analog signal to be converted into a digital signal. In this case, it is possible for the analog-to-digital converting circuits 164a and 164b according to the present embodiment to convert an analog signal corresponding to photoelectric conversion from an imaging region corresponding to each of them into a digital signal. Since both or one of the analog-to-digital converting circuits 164a and 164b include or includes the above-described gain adjusting function, it becomes possible to control exposure or a gain independently for each of the imaging regions.

In the above, the imaging device 150 according to the present embodiment has been described. The imaging device 150, for example, includes the constitution as described in the above. In this connection, the constitution of the imaging device 150 is not restricted to the constitution shown in the above, and the imaging device 150 may include an AGC (Automatic Gain Control) circuit and so on.

(Trigger Adjusting Circuit 152)

The trigger adjusting circuit 152 functions as the imaging control section 102. The trigger adjusting circuit 152 controls imaging for each of the plurality of imaging regions to be set in the pixel circuit 160 on the basis of the plurality of trigger signals. In the case of one example shown in FIG. 1, the trigger adjusting circuit 152 controls the imaging of the imaging region PIX_N on the basis of the trigger signal XTRIG1, and controls the imaging of the imaging region PIX_S on the basis of the trigger signal XTRIG2.

In the above, the hardware constitution example of the control device 100 according to the present embodiment has been described. In this connection, the hardware constitution of the control device 100 according to the present embodiment is not limited to the constitution example shown in FIG. 1.

For example, in the case where the control device 100 controls an external imaging device on the basis of a trigger signal, the control device 100 can take a constitution not including the imaging device 150 shown in FIG. 1.

Moreover, for example, the constitution shown in FIG. 1 may be realized by one or two or more ICs (Integrated Circuit).

[1.3. One Example of Imaging Control by Imaging Control Section 102]

In the above, the control device 100 according to the present embodiment has been described in detail. Next, one example of the imaging control by the imaging control section 102 according to the present embodiment is described.

As mentioned in the above, it is possible for the imaging control section 102 according to the present embodiment to control imaging for each of the imaging regions on the basis of the plurality of trigger signals. At this time, as examples of the imaging control by the imaging control section 102 according to the present embodiment, examples shown in the following (A) to (D) are cited. In this connection, in the below, although a case where one trigger signal corresponds to one imaging region is described as an example, as mentioned in the above, the trigger signal according to the present embodiment may correspond to a plurality of imaging regions.

### (A) First Control Example

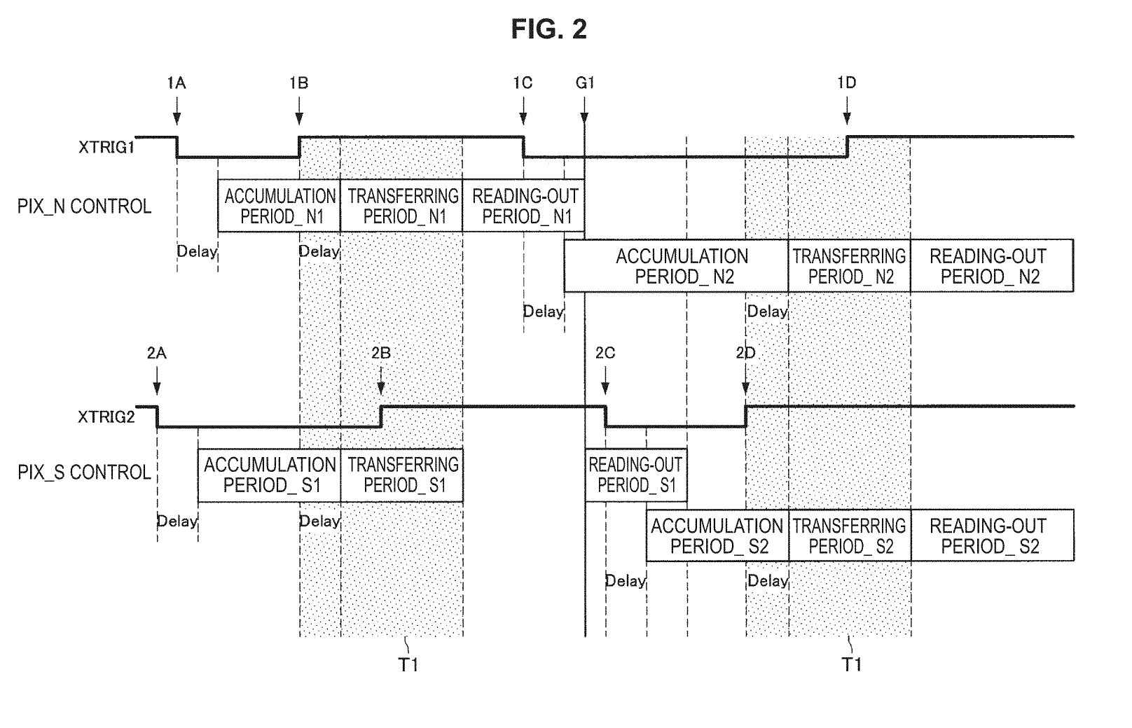

FIG. 2 is an explanatory diagram showing the first control example by the imaging control section 102 according to the present embodiment. In FIG. 2, exemplified is a case where the imaging control section 102 controls two imaging regions PIX_N and PIX_S on the basis of two trigger signals XTRIG1 and XTRIG2.

Here, the imaging region PIX_N may be an imaging region corresponding to the trigger signal XTRIG1. Moreover, the imaging region PIX_S may be an imaging region corresponding to the trigger signal XTRIG2. That is, the imaging control section 102 can control the imaging of the imaging region PIX_N on the basis of the trigger signal XTRIG1, and can control the imaging of the imaging region PIX_S on the basis of the trigger signal XTRIG2.

In this connection, in FIG. 2, the lapse of time is shown on the transverse axis. Namely, in FIG. 2, as a point in the diagram goes to the right side, the point may become a state where time has elapsed more.

Referring to FIG. 2, on the basis of the trigger signals XTRIG1 and XTRIG2, the imaging control section 102 according to the present embodiment is controlling exposure in each of the imaging region PIX_N and PIX_S corresponding to them respectively.

As mentioned in the above, on the basis of a change of a trigger signal corresponding to an imaging region, it is possible for the imaging control section 102 according to the present embodiment to cause accumulation of electric charges to be started in the imaging region.

Referring to FIG. 2, on the basis of a change 1A of the trigger signal XTRIG1, the imaging control section 102 according to the present embodiment causes an accumulation period_N1 of the imaging region PIX_N to be started. Moreover, similarly, on the basis of a change 2A of the trigger signal XTRIG2, the imaging control section 102 according to the present embodiment causes an accumulation period_S1 of the imaging region PIX_S to be started.

At this time, in the first control example according to the present embodiment, the imaging control section 102 makes the imaging region perform a resetting process for light receiving elements and the like in advance of the starting of the accumulation of electric charges. That is, in the first control example according to the present embodiment, after having performed the resetting process for the light receiving elements on the basis of the control of the imaging control section 102, each of the imaging regions starts the accumulation of electric charges. Here, the above-described resetting process refers to an operation for discharging electric charges accumulated in the light receiving elements.

For this reason, in the first control example according to the present embodiment, after a delay (Delay) corresponding to the time necessary for the above-described resetting process from a change of a trigger signal has occurred, the accumulation of electric charges is started. Referring to one example shown in FIG. 2, an accumulation period_N1 in the imaging region PIX_N is started after having interposed a comparatively large delay from a change 1A of an external signal XTRIG1. Moreover, similarly, an accumulation period_S1 in the imaging region PIX_S is started after having interposed a comparatively large delay from a change 2A of an external signal XTRIG2.

Successively, description is given for the control of the accumulation period by the imaging control section 102 in the first control example of the present embodiment. In the first control example of the present embodiment, on the basis of a trigger signal having changed firstly among trigger signals corresponding to the imaging region in which the accumulation of electric charges has been started, the imaging control section 102 causes the accumulation of electric charges to be ended in the imaging region that are starting the accumulation of electric charges.

That is, on the basis of a change of a trigger signal having indicated firstly the ending of the accumulation among the plurality of trigger signals, the imaging control section 102 according to the present embodiment causes the accumulation of electric charges to be ended in all the imaging regions that are performing the accumulation of electric charges.

Referring to FIG. 2, a change 1B of the trigger signal XTRIG1 has occurred antecedent to a change 2B of the trigger signal XTRIG2. In this case, on the basis of the change 1B of the trigger signal XTRIG1 having occurred antecedently, the imaging control section 102 according to the present embodiment causes the accumulation of electric charges to be ended in the imaging regions PIX_N and PIX_S. At this time, the imaging control section 102 according to the present embodiment does not perform the processing on the basis of the change 2B of the XTRIG2 having occurred later. Namely, the change 2B of the XTRIG2 is subjected to masking.

In one example shown in FIG. 2, on the basis of the change 1B of the trigger signal XTRIG1, the imaging control section 102 causes the accumulation period_N1 in the imaging region PIX_N and the accumulation period_S1 in the imaging region PIX_S to be ended. At this time, in the first control example according to the present embodiment, an accumulation period will end with a delay corresponding to the delay (Delay) related to the above-mentioned resetting process and an offset. The imaging control section 102 according to the present embodiment performs the above-described control, whereby it becomes possible to realize exposure different for each of the imaging regions.

Moreover, by performing the above-described control by the imaging control section 102 according to the present embodiment, it becomes possible to synchronize the transferring period of electric charges in each of the imaging regions. Referring to FIG. 2, an accumulation period_N1 in the imaging region PIX_N and an accumulation period_S1 in the imaging region PIX_S are ended simultaneously, and a transferring period_N1 in the imaging region PIX_N and a transferring period_S1 in the imaging region PIX_S are started simultaneously.

In this connection, in the first control example according to the present embodiment, a period from a change of a trigger signal having indicated firstly the ending of the accumulation until the transferring period of electric charges in all the imaging regions is ended, becomes a period (period T1) for prohibiting the starting of accumulation. In the period T1, in the case where a change of a trigger signal related to the starting of accumulation has been detected, the imaging control section 102 according to the present embodiment can mask the change.

Upon completion of the transferring of electric charges in each of the imaging regions, the imaging region according to the present embodiment causes the reading-out of electric charges to be started in each of the imaging regions. At this time, the imaging control section 102 can control a gain at the time of reading out electric charges for each of the imaging regions.

In the case of one example shown in FIG. 1, the imaging control section 102 according to the present embodiment, first, causes the reading-out (reading-out period_N1) of electric charges to be performed with an arbitrary gain in the imaging region PIX_N, and thereafter, performs the switching of the gain at a timing G1. Successively, the imaging control section 102 causes the reading-out (reading-out period_S1) of electric charge to be performed in the imaging region PIX_S with a gain different from that in the imaging region PIX_N.

In this connection, the length of each of the reading-out period_N1 and the reading-out period_S1 changes depending on the imaging region PIX_N and the imaging region PIX_S, respectively. For example, in the case where the imaging regions PIX_N and PIX_S correspond to the ROI1 and the ROI2 shown in FIG. 1, respectively, the reading-out period_N1 and the reading-out period_S1 may change depending on the sizes of the ROI1 and the R012, respectively.

Thus, in the case where the reading-out of electric charges in an imaging region has been completed, by changing the gain in an imaging region for which the next reading-out is performed, it is possible for the imaging control section 102 according to the present embodiment to cause a captured image to be acquired with a gain different for each of the imaging regions.

Moreover, as mentioned in the above, in the first control example according to the present embodiment, the imaging control section 102 makes an imaging region perform the resetting process for light receiving elements in advance of the starting of the accumulation of electric charges. For this reason, in the first control example according to the present embodiment, even during a period in which electric charges are read out, it is possible to make an imaging region newly start accumulation of electric charges.

In one example shown in FIG. 1, the imaging control section 102 causes an accumulation period_N2 to be started in the imaging region PIX_N on the basis of a change 1C of the trigger signal XTRIG1. At this time, as shown in FIG. 1, the accumulation period_N2 may be started before the ending of the reading-out period_N1. Moreover, the imaging control section 102 causes an accumulation period_S2 to be started in the imaging region PIX_S on the basis of a change 2C of the trigger signal XTRIG2. Also in this case, similarly, the accumulation period_S2 may be started before the ending of the reading-out-period_S1.

In this way, in the first control example according to the present embodiment, it is possible to cause the reading-out of electric charges in an imaging region to be performed by a so-called pipeline operation.

In the above, the first control example according to the present embodiment has been described. On the basis of a trigger signal, the imaging control section 102 according to the present embodiment performs the above-described control repeatedly. In one example shown in FIG. 1, on the basis of a change 2D of the trigger signal XTRIG2, the imaging control section 102 causes the accumulation period_N2 in the imaging region PIX_N and the accumulation period_S2 in the imaging region PIX_S to be ended.

At this time, as described in the above, the transferring period_N2 in the imaging region PIX_N and the transferring period_S2 in the imaging region PIX_S are controlled to start simultaneously and to end simultaneously.

In this connection, in the case where the imaging control section 102 does not control a gain at the time of reading out electric charges for each of the imaging regions, i.e., in the case where the imaging control section 102 controls the reading-out of electric charges in all the imaging regions with the same gain, the reading-out of electric charges in each of the imaging regions may be executed simultaneously. In one example shown in FIG. 1, the imaging control section 102 controls the reading-out period_N2 in the imaging region PIX_N and the reading-out period_S2 in the imaging region PIX_S so as to start simultaneously and to end simultaneously.

On the other hand, in the case where the reading-out of electric charges in all the imaging regions is executed simultaneously, a period to read out electric charges in each of the imaging regions will depend on an imaging region with a larger size. In order to avoid the above-described influence, similarly to the reading-out period_N1 and the reading-out period_S1, the imaging control section 102 may control the reading-out period_N2 and the reading-out period_S2 to become before and after relatively.

### (B) Second Control Example

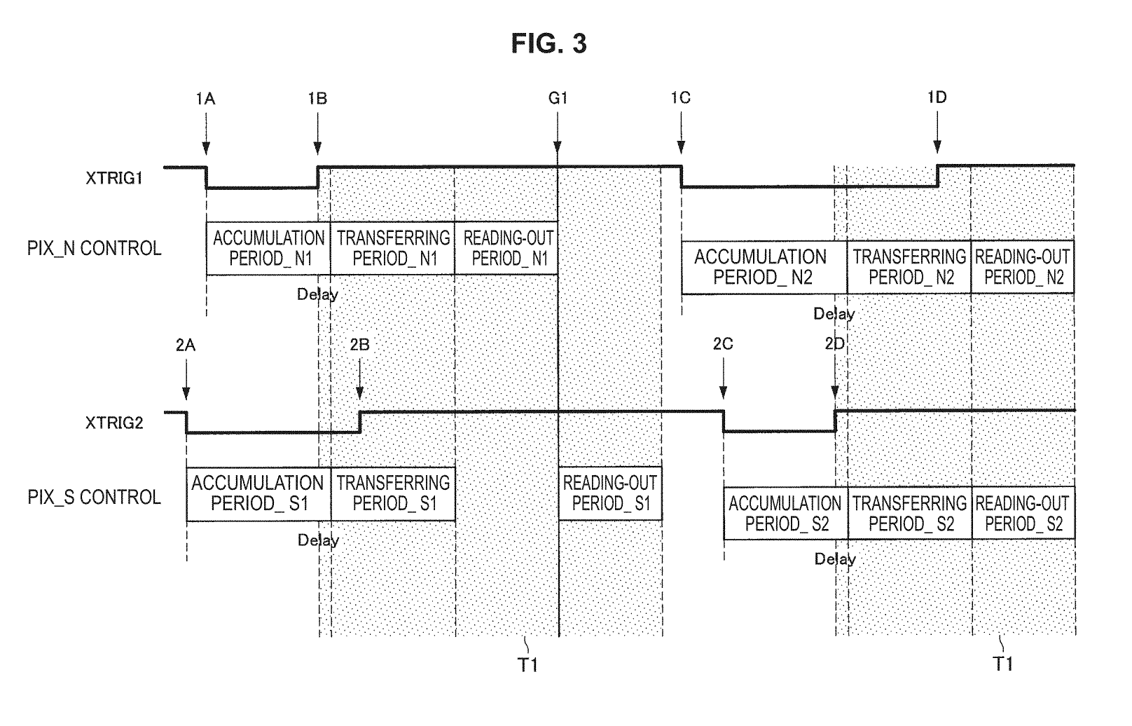

Next, the second control example by the imaging control section 102 according to the present embodiment is described. FIG. 3 is an explanatory diagram showing the second control example by the imaging control section 102 according to the present embodiment. In this connection, in the following description, differences between the first control example and the second control example is described mainly, and description with regard to the overlapping control is omitted.

In the second control example according to the present embodiment, different from the first control example according to the present embodiment, in the case where the reading-out of electric charges has been completed, the imaging control section 102 makes an imaging region perform the resetting process for light receiving elements.

Namely, in the second control example according to the present embodiment, after having performed the reading-out of electric charges on the basis of the control of the imaging control section 102, each of the imaging regions executes the above-described resetting process, and performs standby.

For this reason, when the control of the starting of accumulation by the imaging control section 102 has been performed, it is possible for each of the imaging regions in the second control example according to the present embodiment to start accumulation of electric charges without a delay (Delay) by canceling the standby state.

Referring to FIG. 3, in the second control example according to the present embodiment, on the basis of a change 1A of XTRIG1, an accumulation period_N1 in the imaging region PIX_N is started without a delay (Delay). Moreover, similarly, on the basis of a change 2A of XTRIG2, an accumulation period_S1 in the imaging region PIX_S is started without a delay (Delay).

Moreover, referring to FIG. 3, on the basis of a change 1B of XTRIG1, the imaging control section 102 according to the present embodiment causes the accumulation period_N1 in the imaging region PIX_N and the accumulation period_S1 in the imaging region PIX_S to be ended. At this time, it turns out that the delay (Delay) at the time of ending the accumulation in the second control example according to the present embodiment decreases greatly as compared with the first control example.

That is, in the second control example according to the present embodiment, since there does not exist a delay (Delay) related to a resetting process at the time of starting an accumulation period, a delay (Delay) related to the ending of the accumulation period includes only a delay corresponding to an offset, whereby it is possible to advance the starting of transferring of electric charges.

In the above, the second control example according to the present embodiment has been described. As mentioned in the above, in the second control example according to the present embodiment, in the case where the reading-out of electric charges has been completed, the imaging control section 102 makes an imaging region perform the resetting process for light receiving elements. For this reason, in the second control example according to the present embodiment, it is possible to realize an imaging control with less delay (Delay) as compared with the first control example.

In this connection, with regard to the control of a gain by the imaging control section 102 in the second control example according to the present embodiment, since it may be the same as that of the first control example, detailed description is omitted.

### (C) Third Control Example

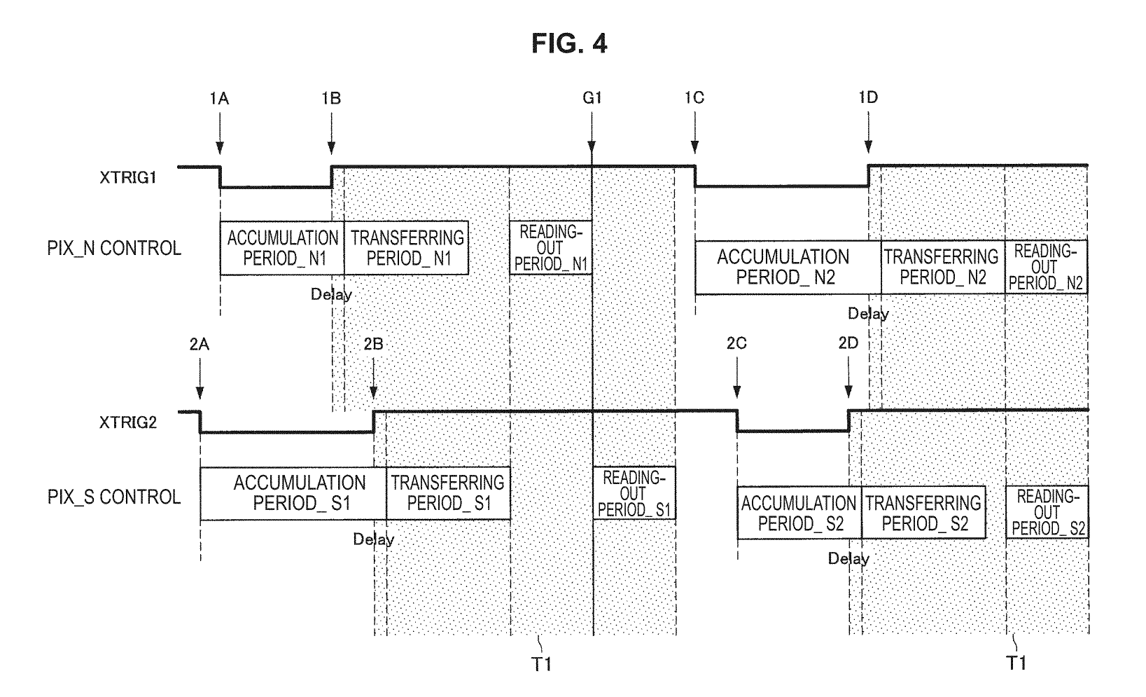

Next, the third control example by the imaging control section 102 according to the present embodiment is described. FIG. 4 is an explanatory diagram showing the third control example by the imaging control section 102 according to the present embodiment. In this connection, in the following description, differences between the first and second control examples and the third control example are described mainly, and description with regard to the overlapping control is omitted.

In the third control example according to the present embodiment, different from the first and second control examples according to the present embodiment, the imaging control section 102 controls the starting and ending of an accumulation period for each of the imaging regions on the basis of a change of a trigger signal corresponding to each of the imaging regions.

Referring to FIG. 4, in the third control example according to the present embodiment, the imaging control section 102 has caused an accumulation period_N1 in the imaging region PIX_N to be started on the basis of a change 1A of a trigger signal XTRIG1, and thereafter, causes the accumulation period_N1 to be ended on the basis of a change 1B of the trigger signal XTRIG1.

Moreover, similarly, the imaging control section 102 has caused an accumulation period_S1 in the imaging region PIX_S to be started on the basis of a change 2A of a trigger signal XTRIG2, and thereafter, causes the accumulation period_S1 to be ended on the basis of a change 2B of the trigger signal XTRIG2.

In this way, in the third control example according to the present embodiment, on the basis of a change of each of the trigger signals, the imaging control section 102 can control the ending of electric charges in an imaging region corresponding to the trigger signal.

For this reason, in the third control example according to the present embodiment, the transferring period of the electric charge in each of the imaging regions may not be made to be synchronized. Referring to FIG. 4, each of a transferring period_N1 in the imaging region PIX_N and a transferring period_S1 in the imaging region PIX_S is started independently, and ended independently.

On the other hand, in the third control example according to the present embodiment, after the transferring of electric charges in all the imaging regions has been completed, the imaging control section 102 controls such that reading-out of electric charged in each of the imaging regions is started.

Referring to FIG. 4, after both of the transferring period_N1 in the imaging region PIX_N and the transferring period_S1 in the imaging region PIX_S have been completed, the imaging control section 102 causes the reading-out period_N1 in the imaging region PIX_N to be started.

In the third control example according to the present embodiment, by performing the above-described control by the imaging control section 102, it becomes possible to control the gain for each of the imaging regions.

In the above, the third control example according to the present embodiment has been described. As mentioned in the above, in the third control example according to the present embodiment, on the basis of a change of a trigger signal corresponding to each of the imaging regions, the imaging control section 102 controls the starting and ending of an accumulation period for each of the imaging regions. For this reason, in the third control example according to the present embodiment, it is possible to control the exposure for each of the imaging regions more flexibly as compared with the first and second control examples.

In this connection, with regard to the control of a gain by the imaging control section 102 in the third control example according to the present embodiment, since it may be the same as that in the first and second control examples, detailed description is omitted.

Moreover, with regard to the control related to the resetting process for the light receiving elements in the third control example according to the present embodiment, it may be the same as that in the second control.

### (D) Fourth Control Example

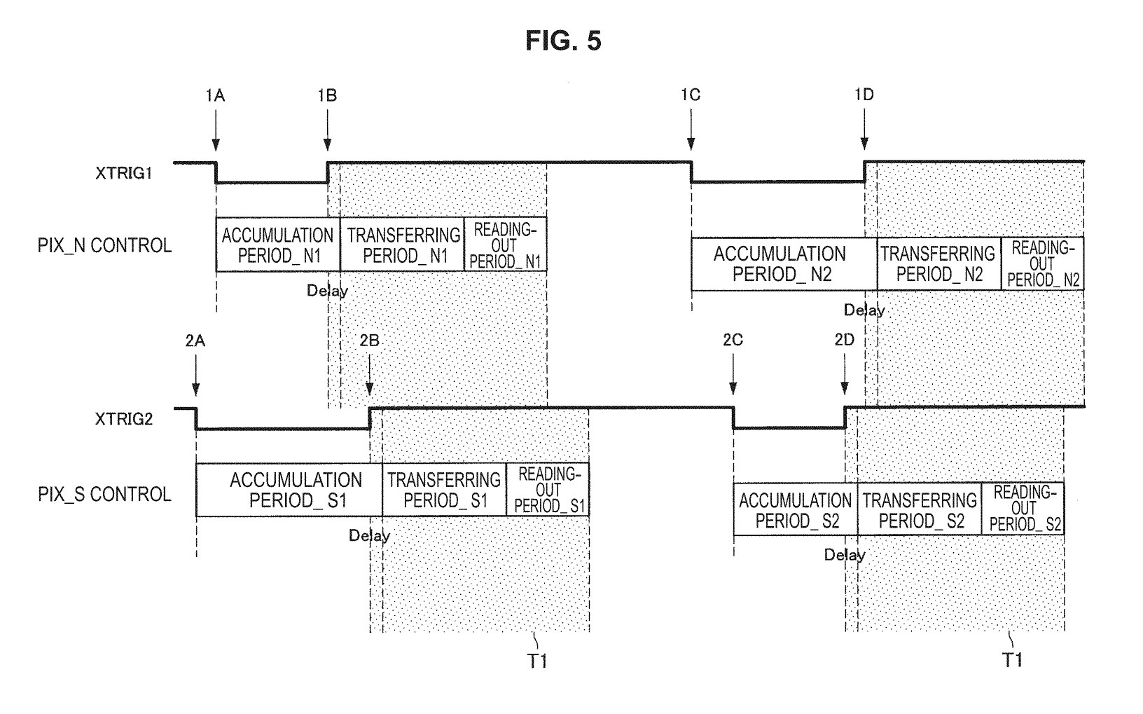

Next, the fourth control example by the imaging control section 102 according to the present embodiment is described. FIG. 5 is an explanatory diagram showing the fourth control example by the imaging control section 102 according to the present embodiment. In this connection, in the following description, differences between the first to third control examples and the fourth control example are described mainly, and description with regard to the overlapping control is omitted.

In the fourth control example according to the present embodiment, different from the first to third control examples according to the present embodiment, the imaging control section 102 controls the accumulating, transferring, and reading-out of electric charges independently for each of the imaging regions on the basis of a change of a trigger signal corresponding to each of the imaging regions.

Referring to FIG. 5, in the fourth control example according to the present embodiment, the imaging control section 102 has caused an accumulation period_N1 in the imaging region PIX_N to be started on the basis of a change 1A of a trigger signal XTRIG1, and thereafter, causes the accumulation period_N1 to be ended on the basis of a change 1B of the trigger signal XTRIG1. At this time, the transferring period_N1 is started without a delay after the ending of the accumulation period_N1, and the reading-out period_N1 is started without a delay after the ending of the transferring period_N1.

Moreover, similarly, the imaging control section 102 has caused an accumulation period_S1 in the imaging region PIX_S to be started on the basis of a change 2A of a trigger signal XTRIG2, and thereafter, causes the accumulation period_S1 to be ended on the basis of a change 2B of the trigger signal XTRIG2. At this time, the transferring period_S1 is started without a delay after the ending of the accumulation period_S1, and the reading-out period_S1 is started without a delay after the ending of the transferring period_S1.

In this way, in the fourth control example according to the present embodiment, different from the first to third control examples, it is possible for the imaging control section 102 to control the transferring and reading-out of electric charges in each of the imaging regions independently.

Referring to FIG. 5, each of the transferring period_N1 in the imaging region PIX_N and the transferring period_S1 in imaging region PIX_S is started independently, and is ended independently. Moreover, each of the reading-out period_N1 in the imaging region PIX_N and the reading-out period_S1 in imaging region PIX_S is started independently, and is ended independently.

As described in the above, by controlling the transferring and reading-out of electric charges in each of the imaging regions independently by the imaging control section 102, in the fourth control example according to the present embodiment, it is possible to control the exposure for each of the imaging regions more flexibly as compared with the first to third control examples.

On the other hand, in the fourth control example according to the present embodiment, as shown in FIG. 5, there is a possibility that some of the reading-out periods of electric charges in the respective imaging regions may overlap. For this reason, similarly to the first to third control examples, in the fourth control example according to the present embodiment, in the case where the reading-out of electric charges in an imaging region has been completed, it is difficult to change the gain in an imaging region for which the next reading-out is to be performed.

For this reason, in the fourth control example according to the present embodiment, the control of a gain different from the first to third control examples may be performed. In the fourth control example according to the present embodiment, for example, a converting circuit (converting circuit capable of switching a gain of an analog signal) capable of adjusting a gain of an analog signal to be converted into a digital signal, may be adopted. That is, in the fourth control example according to the present embodiment, both or one of the above-mentioned analog-to-digital converting circuits 164a and 164b may include the above-described gain adjusting function.

In this case, for example, both or one of the analog-to-digital converting circuits 164a and 164b include or includes a comparator. Then, in the analog-to-digital converting circuit 164 including the comparator, the gain is adjusted by switching a capacitance ratio of a capacitance to be connected to a terminal to be applied with a reference signal and a capacitance to be connected to a terminal to be electrically connected to the pixel circuit 160 in the comparator. At this time, the same reference signal may be supplied to the analog-to-digital converting circuits 164a and 164b.

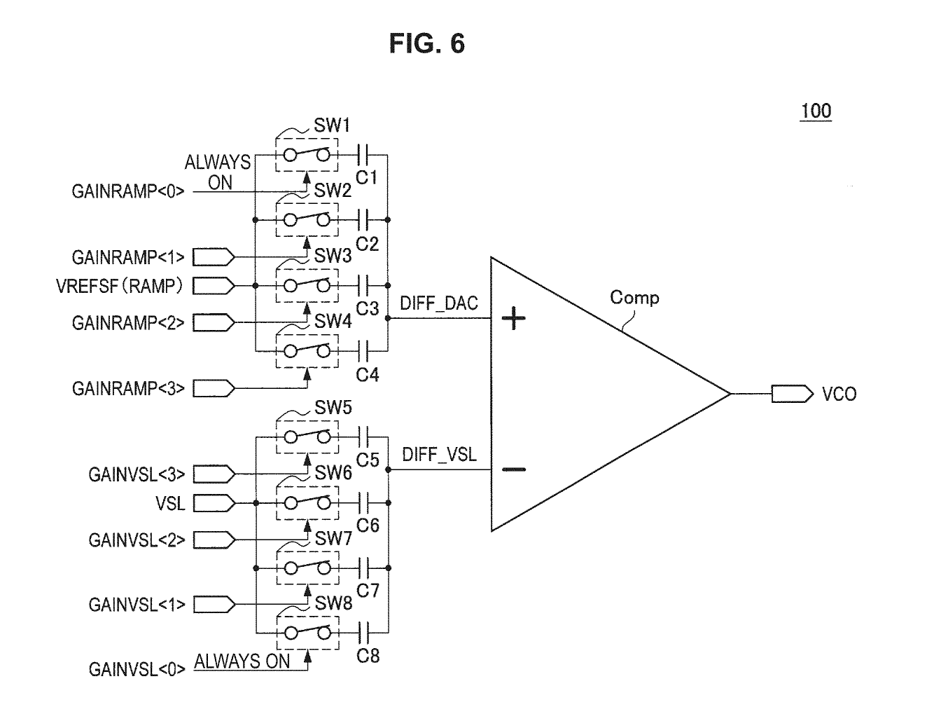

FIG. 6 is an explanatory diagram for describing the analog-to-digital converting circuit 164 in the fourth control example according to the present embodiment, and shows a constitution related to adjustment of a gain among the constitution of the analog-to-digital converting circuit 164, i.e., a part of the constitution of the analog-to-digital converting circuit 164.

The analog-to-digital converting circuit 164 capable of adjusting a gain includes a comparator Comp. A non-inverting input terminal (+) of the comparator Comp is electrically connected to the reference signal generator included in the imaging device 150, and is applied with reference signals. Moreover, an inverting input terminal (−) of the comparator Comp is electrically connected to the pixel circuit 160, and is applied with analog signals.

Moreover, the analog-to-digital converting circuit 164 capable of adjusting a gain includes, for example, a counter circuit (not shown) at a latter stage of the comparator Comp. The counter circuit (not shown) equipped in the analog-to-digital converting circuit 164 capable of adjusting a gain, for example, is provided with counter clocks and a count direction by control signals transmitted from the imaging control section 102, and performs a count operation. Moreover, in the counter circuit (not shown) equipped in the analog-to-digital converting circuit 164 capable of adjusting a gain, a count is reset by control signals transmitted from the imaging control section 102. The counter circuit (not shown) outputs digital signals corresponding to the signal levels of analog signals input into the comparator Comp.

Hereinafter, while referring to FIG. 6, a constitution related to adjustment of a gain among the constitutions of the analog-to-digital converting circuit 164 is described.

To the non-inverting input terminal (+) of the comparator Comp, connected are a plurality of capacitive elements C1, C2, C3, and C4 and switching circuits SW1, SW2, SW3, and SW4 for changing a capacitance to be connected the non-inverting input terminal (+) of the comparator Comp.

Each of the switching circuits SW1, SW2, SW3, and SW4, for example, becomes an ON state (conduction state) or an OFF state (non-conduction state) by a corresponding one signal of control signals GAINRAMP<0>, GAINRAMP<1>, GAINRAMP<2> and GAINRAMP<3> transmitted from the imaging control section 102. In the case where one or two or more of the switching circuits SW1, SW2, SW3, and SW4 becomes or become in an ON state, the capacitive element(s) connected to the switching circuit(s) having become the ON state among the capacitive elements C1, C2, C3, and C4, is or are made a state of having been connected electrically to the non-inverting input terminal (+) of the comparator Comp.

In addition, to the inverting input terminal (−) of the comparator Comp, connected are a plurality of capacitive elements C5, C6, C7, and C8 and switching circuits SW5, SW6, SW7, and SW8 for changing a capacitance to be connected to the inverting input terminal (−) of the comparator Comp.

Each of the switching circuits SW5, SW6, SW7, and SW8, for example, becomes an ON state or an OFF state by a corresponding one signal of control signals GAINVSL<0>, GAINVSL<1>, GAINVSL<2> and GAINVSL<3> transmitted from the imaging control section 102. In the case where one or two or more of the switching circuits SW5, SW6, SW7, and SW8 becomes or become in an ON state, the capacitive element(s) connected to the switching circuit(s) having become the ON state among the capacitive elements C5, C6, C7, and C8, is or are made a state of having been connected electrically to the inverting input terminal (−) of the comparator Comp.

Since the analog-to-digital converting circuit 164 capable of adjusting a gain has a constitution, for example, as shown in FIG. 6, it is possible to switch a capacitance ratio of a capacitance to be connected to a terminal (non-inverting input terminal (+)) to be applied with a reference signal and a capacitance to be connected to a terminal (inverting input terminal (−)) to be electrically connected to the pixel circuit 160 in the comparator Comp.

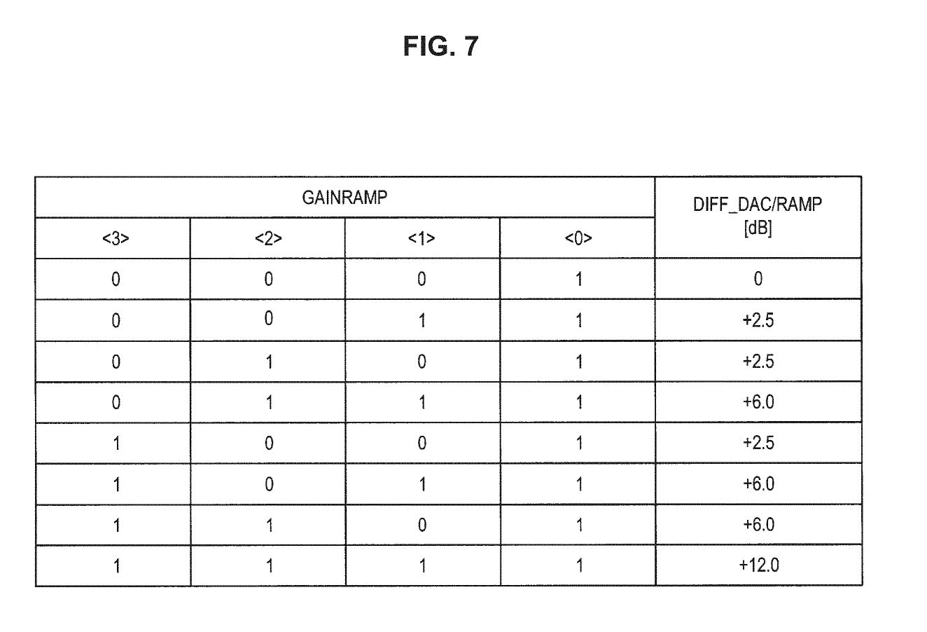

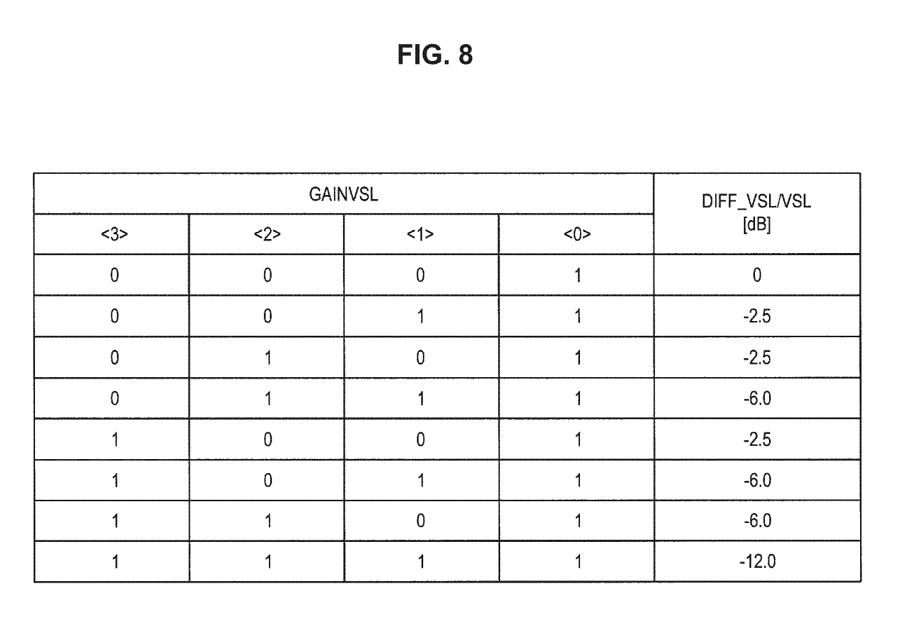

FIG. 7 and FIG. 8 are explanatory diagrams for describing the analog-to-digital converting circuit 164 capable of adjusting a gain according to the present embodiment, and show one example of adjustment of a gain in the analog-to-digital converting circuit 164 capable of adjusting a gain. FIG. 7 and FIG. 8 show an example in which capacitive elements C1, C2, C3, and C4 and capacitive elements C5, C6, C7, and C8 that constitute the analog-to-digital converting circuit 164 capable of adjusting a gain, are 96.74 [fF].

In the analog-to-digital converting circuit 164 capable of adjusting a gain, a gain is adjusted by switching a capacitance ratio of capacitances to be connected to the terminals (the non-inverting input terminal (+) and the inverting input terminal (−)) of the comparator Comp.

In the above, the constitution example of the analog-to-digital converting circuits 164a and 164b in the fourth control example according to the present embodiment has been described. In the fourth control example according to the present embodiment, with the constitution as described in the above, it becomes possible to adjust a gain for each of the imaging regions.

On the other hand, the adjustment of a gain in the fourth control example according to the present embodiment is not limited to the example described in the above. In the fourth control example according to the embodiment, for example, it is also possible to realize it by a control method described in JP 2013-207433A filed by the applicant of the present disclosure. In this case, the analog-to-digital converting circuits 164a and 164b may compare the magnitude relation between reference signals with mutually different inclinations and an analog signal, and then convert the analog signal into a digital signal.

[1.4 Application Example of Control Device According to Present Embodiment]

Although, as the present embodiment, description has been given by citing the control device, the present embodiment is not limited to such a mode. The present embodiment can be applied to, for example, an imaging apparatus equipped with an imaging device used by being installed at a fixed point, such as an industrial camera used in a factory, a physical distribution system, etc., a camera used in ITS, and a security camera. Moreover, the present embodiment is not limited to the above-described examples, for example, can also be applied to a general consumer-oriented imaging device. In this case, for example, a trigger signal on the basis of a shutter operation by a user and the like may be used.

Moreover, the present embodiment can be applied to various devices capable of performing processes related to the control method according to the present embodiment, such as computers, such as a PC (Personal Computer) and a server. Moreover, the present embodiment can be also applied to, for example, a processing IC capable of being incorporated in the above-described imaging apparatus and devices.

Furthermore, it is possible for the control device according to an embodiment of the present disclosure to be applied to, for example, arbitrary movable objects, such as a car, an electric vehicle, a hybrid electric vehicle, a motorcycle, a bicycle, a personal mobility, an airplane, a drone, a marine vessel, and a robot.

Hereinafter, one example of a case where the technology according to the present embodiment is applied to a movable object is described.

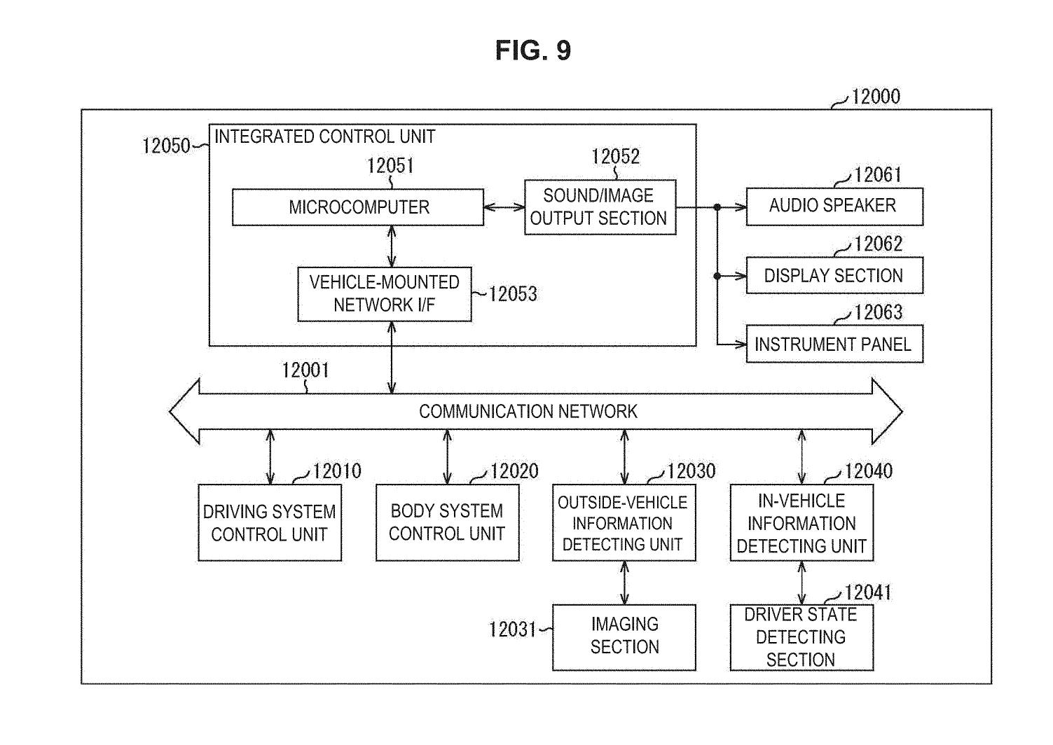

FIG. 9 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 9, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 9, an audio speaker 12061, a display section 12062, and an instrument panel 12063 are illustrated as the output device. The display section 12062 may, for example, include at least one of an on-board display and a head-up display.

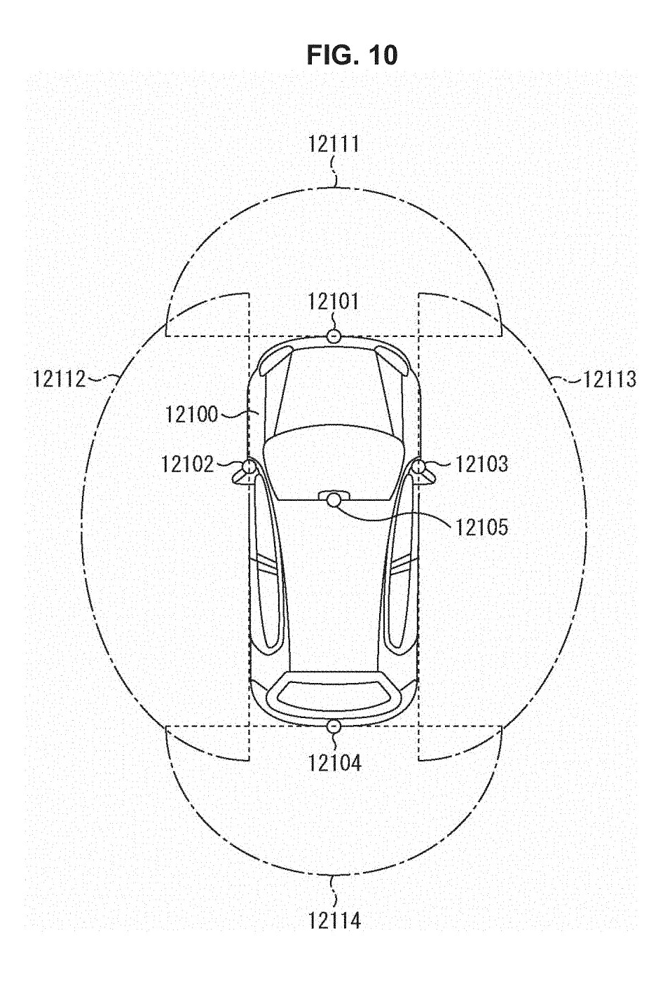

FIG. 10 is a diagram depicting an example of the installation position of the imaging section 12031.

In FIG. 10, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 10 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the above, the one example of the vehicle control system in the case where the technology according to the present embodiment is applied to movable objects has been described. The technology according to the present embodiment may be used for controlling, for example, the imaging unit 12031 in the above-described vehicle control system.

Note that, in this description and the drawings, structural elements that have substantially the same function and structure are sometimes distinguished from each other using different alphabets after the same reference sign. However, when there is no need in particular to distinguish structural elements that have substantially the same function and structure, the same reference sign alone is attached.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A control device, including:

an imaging control section that controls imaging for a plurality of imaging regions to be set in an imaging device on a basis of a plurality of trigger signals.

(2)

The control device according to (1), in which the trigger signals correspond to the imaging regions.

(3)

The control device according to (1) or (2), in which the imaging control section controls accumulation periods of electric charges for the respective imaging regions on a basis of the plurality of trigger signals.

(4)

The control device according to (3), in which the accumulation periods controlled for the respective imaging regions include different periods.

(5)

The control device according to (3) or (4), in which the imaging control section causes accumulation of electric charges to be started in the imaging region on a basis of a change of the trigger signal corresponding to the imaging region.

(6)

The control device according to (5), in which the imaging control section causes the accumulation of electric charges to be ended in the imaging region that is starting the accumulation of electric charges, on a basis of the trigger signal that has changed firstly among the trigger signals corresponding to the imaging region in which the accumulation of electric charges has been started.

(7)

The control device according to any of (1) to (6), in which the imaging control section controls gains at times of reading out electric charges for the respective imaging regions on a basis of the plurality of trigger signals.

(8)

The control device according to (7), in which the gains controlled for the respective imaging regions include gains having different sizes.

(9)

The control device according to (7) or (8), in which the imaging control section causes reading-out of electric charges to be started in the respective imaging regions on a basis of a fact that transferring of accumulated electric charges has been completed in all the imaging regions.

(10)

The control device according to (9), in which in a case where reading-out of transferred electric charges in the imaging region has been completed, the imaging control section changes the gain in an imaging region for which next reading-out is to be performed.

(11)

The control device according to any of (1), (2), (3), (4), (5), (7), and (8), in which the single trigger signal corresponds to the single imaging region, and the imaging control section performs imaging control in the imaging region on a basis of the trigger signal corresponding to the imaging region.

(12)

The control device according to any of (1) to (11), in which the image control section controls imaging in the imaging region on a basis of a mode to be set, and

the mode includes
a first mode that controls imaging for the imaging regions on a basis of the plurality of trigger signals, and
a second mode that controls imaging in all the imaging regions on a basis of the one trigger signal.
   (13)

The control device according to any of (1) to (12), further including:

an imaging section including the imaging device.

(14)

A control method executed by a control device, the control method including:

controlling imaging for a plurality of imaging regions to be set in an imaging device on a basis of a plurality of trigger signals.

### REFERENCE SIGNS LIST

100 control device
102 imaging control section
104 imaging section
150 imaging device
152 trigger adjusting circuit
160 pixel circuit
162 driver
164a and 164b analog-to-digital converting circuit

1. A control device, comprising:
an imaging control section that controls imaging for a plurality of imaging regions to be set in an imaging device on a basis of a plurality of trigger signals.

2. The control device according to claim 1, wherein the trigger signals correspond to the imaging regions.

3. The control device according to claim 1, wherein the imaging control section controls accumulation periods of electric charges for the respective imaging regions on a basis of the plurality of trigger signals.

4. The control device according to claim 3, wherein the accumulation periods controlled for the respective imaging regions include different periods.

5. The control device according to claim 3, wherein the imaging control section causes accumulation of electric charges to be started in the imaging region on a basis of a change of the trigger signal corresponding to the imaging region.

6. The control device according to claim 5, wherein the imaging control section causes the accumulation of electric charges to be ended in the imaging region that is starting the accumulation of electric charges, on a basis of the trigger signal that has changed firstly among the trigger signals corresponding to the imaging region in which the accumulation of electric charges has been started.

7. The control device according to claim 1, wherein the imaging control section controls gains at times of reading out electric charges for the respective imaging regions on a basis of the plurality of trigger signals.

8. The control device according to claim 7, wherein the gains controlled for the respective imaging regions include gains having different sizes.

9. The control device according to claim 7, wherein the imaging control section causes reading-out of electric charges to be started in the respective imaging regions on a basis of a fact that transferring of accumulated electric charges has been completed in all the imaging regions.

10. The control device according to claim 9, wherein in a case where reading-out of transferred electric charges in the imaging region has been completed, the imaging control section changes the gain in an imaging region for which next reading-out is to be performed.

11. The control device according to claim 1, wherein the single trigger signal corresponds to the single imaging region, and
the imaging control section performs imaging control in the imaging region on a basis of the trigger signal corresponding to the imaging region.

12. The control device according to claim 1, wherein the image control section controls imaging in the imaging region on a basis of a mode to be set, and
the mode includes
a first mode that controls imaging for the imaging regions on a basis of the plurality of trigger signals, and
a second mode that controls imaging in all the imaging regions on a basis of the one trigger signal.

13. The control device according to claim 1, further comprising:
an imaging section including the imaging device.

14. A control method executed by a control device, the control method comprising:
controlling imaging for a plurality of imaging regions to be set in an imaging device on a basis of a plurality of trigger signals.
